(19) United States
(12) Patent Application Publication
(10) Pub. No.: US 2008/0289896 A1
(43) Pub. Date: Nov. 27, 2008

(54) Four wheeled utility vehicle

(76) Inventors: Hideyoshi Kosuge, Kobe-shi (JP); Toshinori Oki, Kako-gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/889,746

(22) Filed: Aug. 16, 2007

(30) Foreign Application Priority Data
Aug. 18, 2006 (JP) P2006-223373

(51) Int. Cl. B62D 21/00

(52) U.S. Cl. 180/312

(57) ABSTRACT

The invention provides a four wheeled utility vehicle which can efficiently introduce a cooling air into an engine room from a front side of the vehicle. The vehicle is provided with a cabin arranged between front wheels and rear wheels and accommodating a seat of the vehicle and an operating portion in front of the seat to steer the vehicle; an engine room arranged within the cabin or at a position rearward of the cabin to accommodate an engine of the vehicle therein, and configured to be covered by a wall surface at least in a front side and an upper side of the engine; an air duct extending forward from the engine room, and introducing an engine room cooling air into the engine room.

### BACKGROUND OF THE INVENTION

1. Field of the Invention

The present invention relates to a four wheeled utility vehicle, particularly, relates to an engine room cooling structure thereof.

2. Description of the Related Art

FIG. 8 shows an example of a conventional four wheeled utility vehicle. The vehicle includes a cabin 110 which is provided between a pair of right and left front wheels 101 and a pair of right and left rear wheels 102, an engine room 103 arranged under a seat 104 in the cabin 110, and an engine 105 accommodated in the engine room 103. The engine room 103 is generally surrounded by a front wall 111 covering a front side of the engine 105, an upper wall 112 covering an upper side of the engine 105, and an under guard 106 covering a bottom side of the engine 105. In this case, since the engine room 103 in FIG. 8 is shown by a cross section, side walls of the engine room 103 is not illustrated, however, right and left sides of the engine room 103 are surrounded by the side walls.

In the four wheeled utility vehicle mentioned above, an opening 107 is formed in the under guard 106 for cooling the engine room 103, and air is introduced from under a bottom of a vehicle body into the engine room 103 via the opening 107, as shown by an arrow W0, so as to be utilized for cooling the engine 105 or the like.

Japanese Unexamined Patent Publication No. 2000-280762 discloses a cooling structure of an engine room of a truck or the like, in which an opening is formed in the side wall of the engine room and cooling air is introduced into the engine room from the opening of the side wall.

In the case of the prior art as shown in FIG. 8, in which the opening portion 107 is formed in the under guard 106 under the engine room 103 so as to take in the cooling air from under the vehicle body into the engine room 103, a mud or a pebble thrown up by the front wheels 101 makes an intrusion into the engine room 103 through the opening portion 107, and the mud is piled up within the engine room 103 or attached to the engine itself. Further, in the case of mounting a high-power engine, it is hard to sufficiently cool only by the air taken from under the vehicle body, therefore the engine room 103 becomes high temperature.

Further, even if the cooling structure in which the opening is formed in the side wall of the engine room of the truck is applied to the engine room of the four wheeled utility vehicle, it is so hard to efficiently utilize the air taken from the opening in the right and left side walls for cooling the engine positioned in a center portion, because the engine of the four wheeled utility vehicle is arranged in a center portion of a lateral width of the vehicle body, and various equipments, for example, a fuel tank, a battery and the like are frequently stored in the right and left sides of the engine.

### SUMMARY OF THE INVENTION

The present invention addresses the above condition, and an object of the present invention is to provide a four wheeled utility vehicle which can efficiently introduce a cooling air into an engine room from a front side.

In order to achieve the object, in accordance with the present invention, there is provided a four wheeled utility vehicle comprising: a cabin arranged between front wheels and rear wheels and accommodating a seat of the vehicle and an operating portion in front of the seat to steer the vehicle; an engine room arranged within the cabin or at a position rearward of the cabin to accommodate an engine of the vehicle therein, and configured to be covered by a wall surface at least in a front side and an upper side of the engine; an air duct extending forward from the engine room, and introducing an engine room cooling air into the engine room.

With this configuration, since the air is taken into the engine room from before the engine room by the air duct extending forwards from the engine room, it is possible to efficiently take a fresh air into the engine room during a travel, and a cooling effect of the engine is improved. Moreover, since the wall surfaces surround the engine room, it may be possible to prevent a vibration noise or a machine noise of the engine within the engine room from leaking to the cabin room. Further, since it is not necessary to form the opening in the prior art in FIG. 8 under the engine room, it may be possible to prevent the mud or the pebble from making an intrusion into the engine room.

Preferably, in the four wheeled utility vehicle, the air duct may be extended to a position forward of the cabin.

With this configuration, it is possible to further efficiently introduce a running wind into the engine room during the travel, and the leakage of the vibration noise or the machine noise into the cabin can be reduced.

Further, preferably, in the four wheeled utility vehicle, the air duct may be risen to extend upward at a position forward of the cabin.

With this configuration, since it is possible to set an air inlet of the air duct at a high position, it is possible to effectively prevent the mud or water from making an intrusion from the air inlet.

Further, preferably, in the four wheeled vehicle, the vehicle further comprises a bonnet provided at a position forward of the cabin to cover a space between the front wheels; and a radiator to cool coolant of the engine and positioned below the bonnet, wherein the air duct has the air inlet which is opened at an upper position than the radiator and under the bonnet.

With this configuration, it is possible to prevent the mud or the water from making an intrusion from the air inlet, it is possible to prevent a warm air from being taken from the radiator, and it is possible to supply a fresh air into the engine room.

Further, preferably, in the four wheeled vehicle, a floor surface to support feet of a rider and position the feet in place, in front of the seat is provided with a protruded portion protruding upward from the floor surface and having an inverted U-shape in which a lower portion is opened, the protruded portion being positioned in a center portion in a width direction of the vehicle and extending in a longitudinal direction of the vehicle, and the air duct is arranged in an inner portion of the protruded portion, so as to extend in the longitudinal direction along the protruded portion.

With this configuration, a driver or a passenger does not directly treat on the air duct, and it is possible to protect the air duct.

The above and further object and feature of the invention will more fully be apparent from the following detailed description with accompanying drawings.

### BRIEF DESCRIPTION OF THE DRAWINGS

FIG. 1 is a left side elevational view showing an embodiment of a four wheeled utility vehicle provided with an engine room cooling structure in accordance with the present invention;

FIG. 2 is a simplified perspective view of the four wheeled utility vehicle of FIG. 1;

FIG. 3 is a plan view of the four wheeled utility vehicle of FIG. 1;

FIG. 4 is a cross sectional view along a line IV-IV in FIG. 3;

FIG. 5 is a cross sectional view along a line u

FIG. 6 is a cross sectional view along a line VI-VI in FIG. 1;

FIG. 7 is a horizontal cross sectional view showing the other embodiment of a four wheeled utility vehicle in accordance with the present invention; and

FIG. 8 is a left side elevational schematic view of a prior art.

### DESCRIPTION OF THE PREFERRED EMBODIMENT

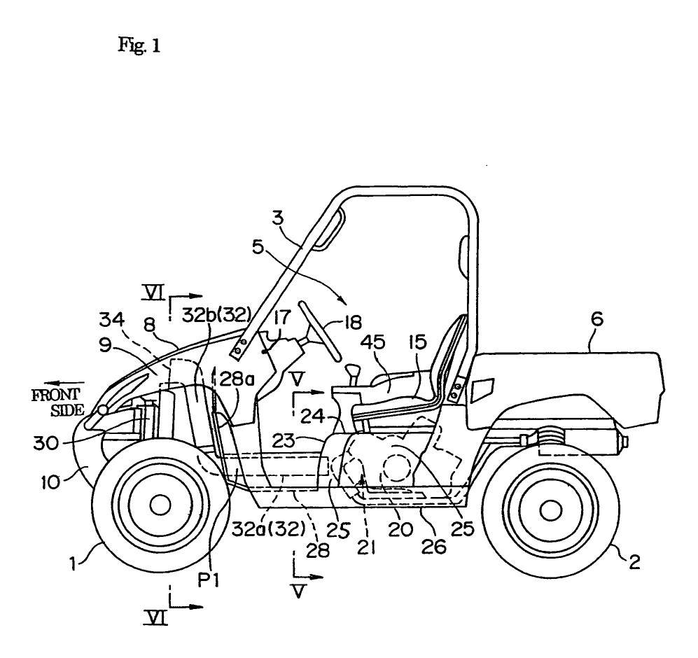

FIGS. 1 to 6 show an embodiment of a four wheeled utility vehicle in accordance with the present invention. A description will be given of the present invention with reference to these drawings. In this case, in a concept of directions used for the following description, a front side as seen from a rider riding on the vehicle shown in FIG. 1, that is, a direction in which the vehicle moves forward is called a front side of the vehicle and each of constituting elements of the vehicle, except as otherwise specified.

### [Whole Structure of Four Wheeled Utility Vehicle]

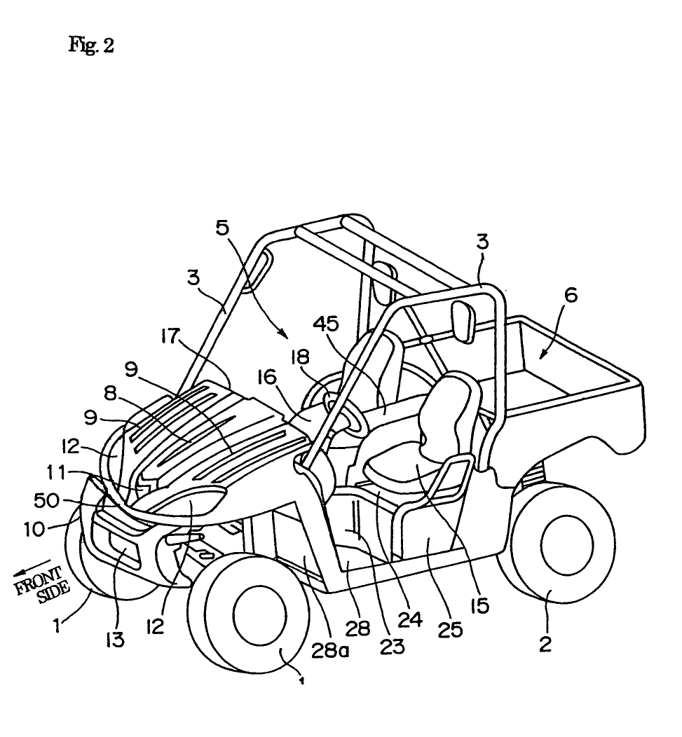

FIG. 2 is a simplified perspective view of the four wheeled utility vehicle. A pair of right and left front wheels 1 are provided in a front portion of the vehicle, a pair of right and left rear wheels 2 are provided in a rear portion of the vehicle, a cabin 5 surrounded by a protecting frame 3 is provided between the front wheels 1 and the rear wheels 2, and a back carrier 6 is provided behind the cabin 5. Further, the vehicle is provided with a bonnet 8, a pair of front fenders 9 and a bumper 10 in front of the cabin 5. The bonnet 8 covers a space formed between the right and left front wheels 1 at a front portion of the vehicle. The front fenders 9 are arranged in right and left sides of the bonnet 8 and cover upper sides and rear sides of the front wheels 1. The bumper 10 is provided at a front head portion of the vehicle and is positioned at forward downward position of the bonnet 8. The cabin 5 is open at a front portion, right and left side portions, an upper portion and a rear portion. In other words, the cabin 5 is not provided with a front glass, side doors or a ceiling wall or the like.

The front and left front fenders 9 are integrally formed with the bonnet 8, a first air intake port 11 is formed in a front end portion of the bonnet 8, and a second air intake port 13 is formed in a front end portion of the bumper 10. Further, a head light 12 is provided in a front end portion of each of the front fenders 9.

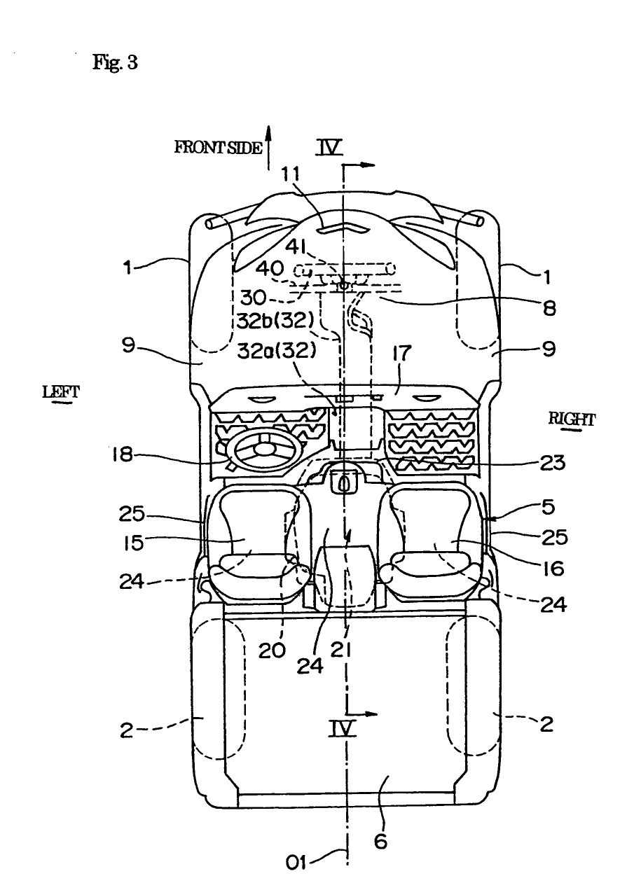

FIG. 3 is a plan view of the four wheeled utility vehicle showing in a state in which the protecting frame 3 (FIGS. 1 and 2) is detached. A driver seat 15 and an assistant driver seat 16 are respectively installed in a left side and a right side, in a rear portion within the cabin 5, and a dashboard (an operating portion) 17 is provided in a front portion within the cabin 5. A left side portion of the dashboard 17 is provided with a handle 18 for steering the vehicle. The handle 18 is positioned in front of the driver seat 15. Further, vehicle meters and switches are provided within the dashboard 17.

An engine room 21 is provided at a lower position than each of the seats 15 and 16 between the driver seat 15 and the assistant driver seat 16, and an engine 20 is mounted within the engine room 21. The engine room 21 is expanded to a space under the left and right seats 15 and 16 and, equipments, for example, a battery (not shown), electrical equipments and the like are accommodated in the expanded space under the driver seat 15 and equipments, for example, a fuel tank (not shown) is accommodated in the expanded space under the assistant driver seat 16.

FIG. 1 is a left side elevational view of the four wheeled utility vehicle. The engine room 21 is covered in a front side by a front wall 23 and is covered in an upper side by an upper wall 24, and the front wall 23 and the upper wall 24 respectively extend right and left to the expanded spaces under the seats 15 and 16. Right and left sides of the engine room 21 are respectively covered by a side wall 25, and a lower side of the engine room 21 is covered by an under guard 26.

A rear side of a center portion of the engine room 21 in a vehicle width direction, that is, a rear side of the engine room 21 accommodating the engine 20 is open, and the rear sides of the expanded spaces under the left and right seats 15 and 16 are covered by rear fenders (not shown). Further, a console box 45 positioned between the left and right seats 15 and 16 is provided in an upper side of the upper wall 24 in the center portion of the vehicle width of the engine room 21 in the vehicle with direction.

A floor plate 28 is formed at the lower end portion of the cabin 5 to support feet of the rider and extends approximately horizontally forward from the lower end of the front wall 23 of the engine room 21. A rising wall 28a is formed in a front end of the floor plate 28 and rises up from a lower position which is somewhat in front of the dashboard 17. The cabin 5 is partitioned from the space below the bonnet 8 and the front fender 9 in front of the cabin by the rising wall 28a. Further, a radiator 30 is provided in the space below the bonnet 8.

### [Engine Room Cooling Structure]

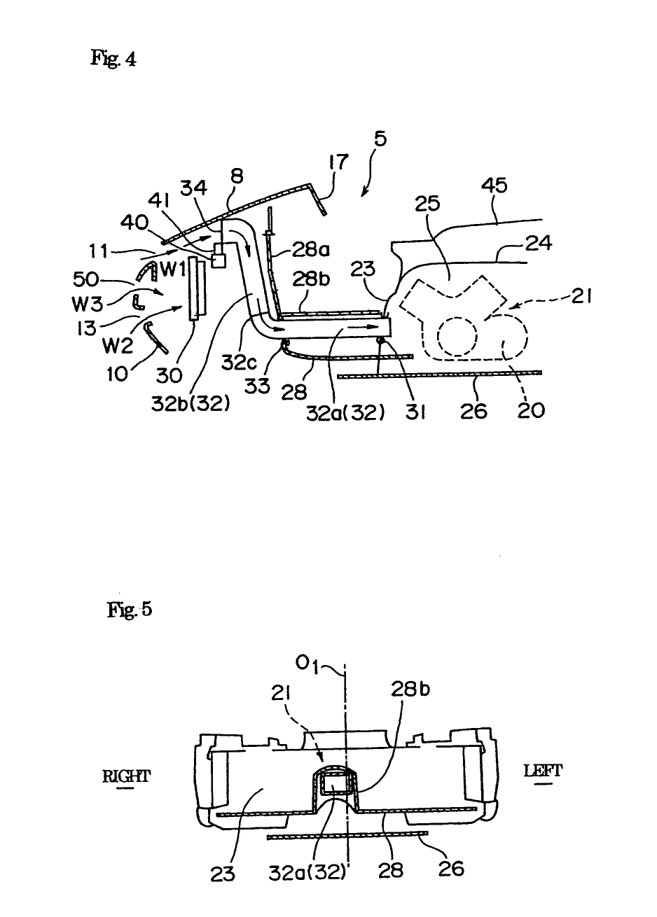

FIG. 4 is a cross sectional schematic view along a line IV-IV in FIG. 3. A duct mounting hole 31 is formed in the front wall 23 of the engine room 21, a rear end portion of an air duct 32 configured to guide cooling air for cooling the engine room is fixed to the mounting hole 31 via a trim seal, and a rear end of the air duct 32 is open to the engine room 21.

The air duct 32 extends forward from the duct mounting hole 31 approximately in parallel to the floor plate 28, and passes through a through hole 33 formed in the rising wall 28a of the floor plate 28 so as to protrude into the space under the bonnet 8 from the inner side of the cabin 5. Further, the air duct 32 rises within the space under the bonnet 8 and extends along a front surface of the rising wall 28a, an upper end portion of the air duct 32 is bent forward at a position near the lower surface of the bonnet 8, and a front end of the air duct is open toward the front side of the vehicle to form an air inlet 34 of the air duct 32.

The air inlet 34 of the air duct 32 is positioned in an upper side than an upper end of the radiator 30, and an upper end of the air duct 32 is supported to a vehicle body frame 40 installed in a lateral direction within the bonnet 8 via a bracket 41.

The air duct 32 is constituted by two members comprising a rear duct member 32a and a front duct member 32b, the rear duct member 32a corresponds to a member extending approximately horizontally to a front position of the rising wall 28a from the front wall 23 of the engine room 21, and the front duct member 32b corresponds to a member extending upwardly along a front surface of the rising wall 28a. A front end portion of the rear duct member 32a and a rear end of the front duct member 32b are connected by a fitting joint structure 32c.

FIG. 5 is a cross sectional view along a line V-V in FIG. 1. An inverted U-shaped protruded portion 28b opening downward is formed on the floor plate 28 which is formed in a flat surface shape in front of the seat. The protruded portion 28b protrudes upward from the flat surface of the floor plate 28. The protruded portion 28b is positioned in a center portion in the width direction of the vehicle, more precisely at a position which is slightly deviated to a right side from a vehicle width center line O1, and extends in a longitudinal direction of the vehicle, and the rear duct member 32a of the air duct 32 is accommodated within the inverted U-shaped protruded portion 28b so as to extend along the protruded portion. Therefore the rear duct member 32a of the air duct 32 is positioned so as to be slightly deviated to the right side from the vehicle width center line O1.

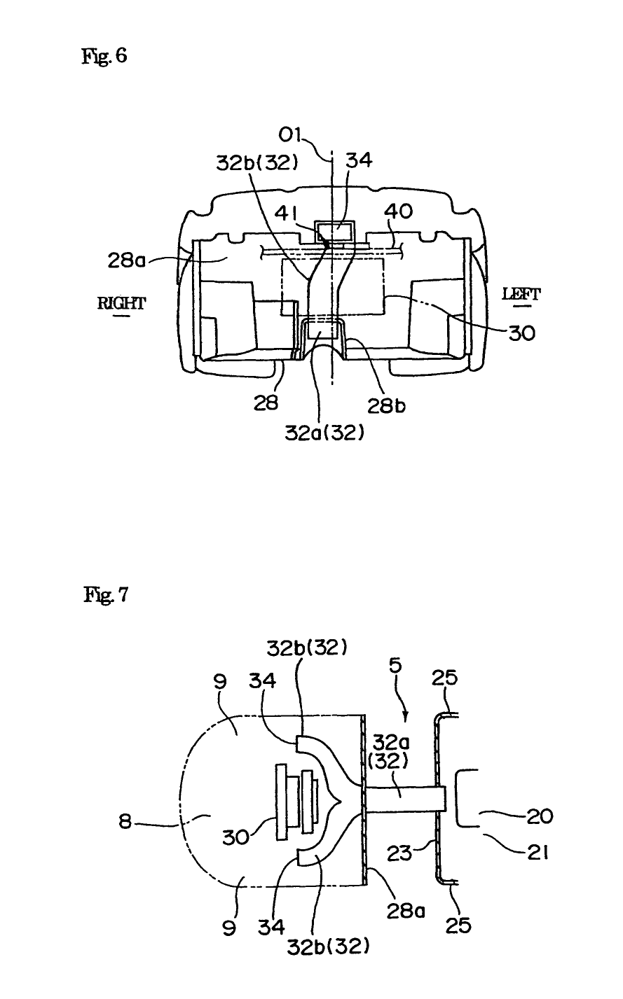

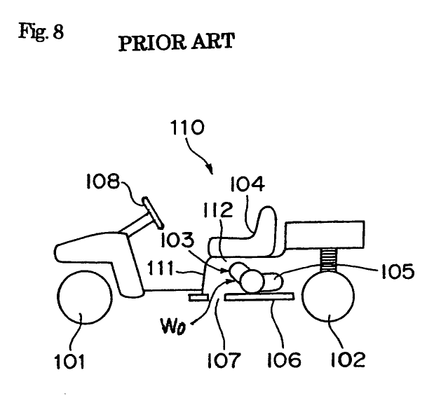

FIG. 6 is a cross sectional view along a line VI-VI in FIG. 1. The rear duct member 32a of the air duct 32 is arranged at the position which somewhat displaces to the right side from the vehicle width center line O1 as mentioned above, however, the front duct member 32b of the air duct 32 is inclined to the left side on the way to the rising, whereby the air inlet 34 in the upper end portion is approximately positioned on the vehicle width center line O1.

### [Operation]

In FIG. 2, during the forward running of the vehicle, fresh air is taken into the bonnet 8 from each of the first air intake port 11 of the bonnet 8, the second air intake port 13 of the bumper 10, and a gap 50 between the front lower ends of the bonnet 8 and the front fender 9 and the upper end of the bumper 10.

In FIG. 4, the air flowing from the first air intake port 11 of the bonnet 8 mainly flows rearward along a lower surface of the bonnet 8 as shown by an arrow W1, and is taken into the air duct 32 from the air inlet 34. The air taken in the air duct 32 flows within the air duct 32, passes through the front wall 23 of the engine room 21, is introduced to the engine room 21, and cools the engine 20, the right and left fuel tanks, the battery and the like. The air after cooling is discharged rearward from the open portion in the rear portion of the vehicle width center portion of the engine room 21.

The air taken from the second air intake port 13 of the bumper 10 and the gap 50 is mainly supplied to the radiator 30 as shown by arrows W2 and W3, and is discharged to the rear side of the radiator 30 after cooling coolant within the radiator 30.

### Effects of Embodiment

(1) In FIG. 4, since it is possible to continuously supply the fresh air taken from the front side of the vehicle into the engine room 21 during the travel, it is possible to efficiently cool the engine 20, the fuel tank and the like accommodated within the engine room 21.

(2) In FIG. 4, since the engine room 21 is isolated from the cabin 5 by the front wall 23 and the upper wall 24, it is possible to prevent the vibration noise and the machine noise of the engine 20 from leaking into the cabin 5. Further, since the lower side of the engine room 21 is covered by the under guard 26 and the opening for taking the air is not formed in the under guard 26 as is different from the conventional structure, the mud and the pebble do not fly into the engine room 21 from the lower side of the vehicle body, and it is possible to protect the engine 20 form the mud and the pebble.

(3) In FIG. 4, since the rear duct 32a of the air duct 32 passing through the lower end portion of the cabin 5 is covered by the inverted U-shaped protruded portion 28b of the floor plate 28, there is no risk that the rear duct 32a is treaded directly by the occupant.

(4) In FIG. 4, since the front duct member 32b of the air duct 32 is risen, and the air inlet 34 is open forward at the high position (near an inner surface of the bonnet) within the bonnet 8, it is possible to prevent the mud and the water thrown up by the front wheels 1 from making an intrusion from the air inlet 34, as well as it is possible to efficiently take in the running wind.

(5) In FIG. 4, since the air inlet 34 in the upper end of the air duct 32 is open at the upper position than the upper end of the radiator 30, it is possible to prevent the warm air after passing through the radiator 30 from being taken in.

### Other Embodiments

(1) FIG. 7 is the horizontal cross sectional schematic view of the other embodiment. In this embodiment, the front duct member 32b of the air duct 32 is branched into right and left side portions, and is open forward at right and left side positions of the radiator 30. With this structure, it is possible to prevent the warm air after passing through the radiator 30 from being sucked by the air duct 32. In this case, the other structures than the air duct 32 are the same as those of the embodiment in FIGS. 1 to 6, in FIG. 7, and the same reference numerals are attached to the same parts.

(2) In the structure shown in FIG. 1, the air duct 32 is structured so as to pass through the rising wall 28a forward and be open at the position forward of the cabin 5, however, the present invention is not limited to the structure mentioned above, but may be structured, for example, such that the air duct 32 is extended to a position P1 within the cabin 5 from the front wall 23 of the engine room 21 so as to be open forward at the position P1, in FIG. 1.

(3) In the structure in FIGS. 1 and 5, the air inlet 34 of the air duct 32 is open forward, however, may be structured so as to be open upward. In this case, the structure may be made, for example, such that a guide surface or the like is formed in a lower surface of the bonnet 8 so as to introduce the air from the front side to the upward opened air inlet by the guide surface mentioned above.

(4) In the four wheeled utility vehicle in FIG. 1, the position in the longitudinal direction of the engine 20 is approximately below the seats 15 and 16, however, the present invention can be applied to the four wheeled utility vehicle structured such that the engine room 21 is formed in a rear side of the seats 15 and 16 to install the engine 20.

(5) The present invention is not limited to each of the embodiments mentioned above, but can employ various modified embodiments within the scope of claims.

What is claimed is:

1. A four wheeled utility vehicle comprising:
a cabin arranged between front wheels and rear wheels and accommodating a seat of the vehicle and an operating portion in front of the seat to steer the vehicle;
an engine room arranged within the cabin or at a position rearward of the cabin to accommodate an engine of the vehicle therein, and configured to be covered by a wall surface at least in a front side and an upper, side of the engine;
an air duct extending forward from the engine room, and introducing an engine room cooling air into the engine room.

2. The four wheeled utility vehicle as claimed in claim 1, wherein the air duct is extended to a position forward of the cabin.

3. The four wheeled utility vehicle as claimed in claim 2, wherein the air duct is risen to extend upward at a position forward of the cabin.

4. The four wheeled utility vehicle as claimed in claim 3 further comprising.
a bonnet provided at a position forward of the cabin to cover a space between the front wheels; and
a radiator to cool coolant of the engine and positioned below the bonnet,
wherein the air duct has an air inlet which is opened at an upper position than the radiator and under the bonnet.

5. The four wheeled utility vehicle as claimed in claim 2, wherein a floor surface to support feet of a rider and position the feet in place, in front of the seat is provided with a protruded portion protruding upward from the floor surface and having an inverted U-shape in which a lower portion is opened, the protruded portion being positioned in a center portion in a width direction of the vehicle and extending in a longitudinal direction of the vehicle, and the air duct is arranged in an inner portion of the protruded portion, so as to extend in the longitudinal direction along the protruded portion.
